(19) United States
(12) Patent Application Publication
(10) Pub. No.: US 2026/0043513 A1
(43) Pub. Date: Feb. 12, 2026

(54) FOOT TUBE LOCKING STRUCTURE FOR TRIPOD

(71) Applicant: Guangdong Laitu Imaging Technology Co.,Ltd, Zhongshan (CN)

(72) Inventor: Tongling DENG, Zhongshan (CN)

(73) Assignee: Guangdong Laitu Imaging Technology Co.,Ltd, Zhongshan (CN)

(21) Appl. No.: 18/801,201

(22) Filed: Aug. 12, 2024

(51) Int. Cl. F16M 11/36

(52) U.S. Cl. CPC F16M 11/36; F16M 2200/024; F16M 2200/08

(57) ABSTRACT

The present invention discloses a foot tube locking structure for a tripod, including a gimbal base and a foot tube, where one end of the foot tube is rotatably connected to the gimbal base, a locking tooth base is disposed on the gimbal base, a plurality of locking tooth grooves are arranged on the locking tooth base along a rotating direction of the foot tube, a locking element embedded into any one of the locking tooth grooves is movably disposed on the foot tube, a locking mechanism is disposed on the foot tube, and the locking mechanism is configured to perform position locking on the locking element, to constrain the locking element from separating from the locking tooth groove. According to the present invention, based on the locking mechanism, the foot tube may be prevented from being folded inward, use stability of the tripod may be effectively improved.

### TECHNICAL FIELD

The present invention relates to a foot tube locking structure for a tripod.

### BACKGROUND

In the prior art, for example, a Chinese utility model document with publication No. CN202992564U discloses a tripod capable of being reversely folded quickly, including a body with three branches and a foot tube assembly, where a U-shaped notch hinged with the branch is disposed at an upper end of the foot tube assembly, a bracket is disposed on a bottom surface of the notch, a manual control plate is hinged at the other end of the bracket through a pin shaft, and a torsion spring enabling the manual control plate to perform swinging branching to be reset is sleeved on the pin shaft; a clamping opening is formed beside the notch, a clamping table capable of falling into the clamping opening is disposed at an upper end of the manual control plate, and a pressing portion at a lower end of the manual control plate is located below the outside of the notch; a tooth-shaped boss that matches with a middle portion of the upper end of the manual control plate and that is configured to control an unfolding angle of the foot tube assembly is disposed on an outer side of the branch; and a lower end surface of the clamping table is in surface contact with a lower side surface of the clamping opening.

Based on the above description, in the prior art, the manual control plate is engaged with the tooth-shaped boss, so that the foot tube is constrained from flipping outward, to lock the foot tube. However, angle locking of the foot tube merely constrains the foot tube from flipping outward, the foot tube may be folded inward, and the manual control plate does not need to be pressed when the foot tube is folded inward, so that when a strong acting force is applied to the tripod, for example, when the tripod is used with a gun, a recoil force generated by the gun applies a strong acting force to the tripod, and the foot tube is folded inward, thereby affecting stability of the tripod at a light degree or resulting in collapse of the tripod at a heavy degree.

Meanwhile, a Chinese invention patent application document with publication No. CN114251581A discloses an adjusting structure and a tripod, where the adjusting structure includes a base, an adjusting rod, an adjusting knob, and a reset elastic member, the adjusting rod is hinged with the base, a gap is reserved between the adjusting rod and the base, and the adjusting knob is placed in the gap and may slide along the gap; when the adjusting knob is located at an initial position, the base is fixedly connected to the adjusting rod; when the adjusting knob is located at an adjusting position, the adjusting rod may rotate relative to the base; and the reset elastic member is connected to the adjusting knob and the adjusting rod and resets the adjusting knob. In the structure, the movably disposed adjusting knob is locked with a step surface in an engaging manner. The foot tube locking structure also has a problem that the foot tube cannot be constrained from being folded inward and can only constrain the foot tube from flipping outward.

In conclusion, in an existing tripod, the foot tube cannot be constrained from being folded inward. When a strong acting force is applied to the tripod, the foot tube is folded inward, thereby affecting stability of the tripod at a light degree or resulting in collapse of the tripod at a heavy degree. Further structural optimization is needed for an existing foot tube.

### SUMMARY

The present invention aims to at least solve one of technical problems existing in the prior art. Therefore, the present invention provides a foot tube locking structure for a tripod.

According to the purpose, a foot tube locking structure for a tripod is provided and includes a gimbal base and a foot tube, where one end of the foot tube is rotatably connected to the gimbal base, a locking tooth base is disposed on the gimbal base, a plurality of locking tooth grooves are arranged on the locking tooth base along a rotating direction of the foot tube, a locking element embedded into any one of the locking tooth grooves is movably disposed on the foot tube, a locking mechanism is disposed on the foot tube, and the locking mechanism is configured to perform position locking on the locking element, to constrain the locking element from separating from the locking tooth groove.

Preferably, the locking element includes a connecting plate and a locking plate, the connecting plate is disposed on the foot tube, a middle portion of the locking plate is hinged with the connecting plate, and an upper portion of the locking plate extends into any one of the locking tooth grooves; and
the locking mechanism abuts against a lower side wall surface in the locking plate, to constrain a lower portion of the locking plate from flipping inward.

Preferably, the locking mechanism includes a locking rod moving upward and downward relative to the foot tube, and the locking rod may move between a first position and a second position relative to the foot tube;
when the locking mechanism is in a locking state, the locking rod is located at the second position, and the locking rod abuts against the lower side wall surface in the locking plate; and
when the locking mechanism is in an unlocking state, the locking rod is located at the first position, the locking rod is separated from the lower side wall surface in the locking plate, and the locking plate may rotate relative to the connecting plate, to enable the upper portion of the locking plate to be separated from the locking tooth groove.

Preferably, the locking element further includes an elastic element, one end of the elastic element is connected to the lower portion of the locking plate, the other end thereof is connected to the connecting plate or the foot tube, and the elastic element is configured to apply an outward movement acting force to the lower portion of the locking plate.

Preferably, the locking element includes a connecting plate and a locking plate, where the connecting plate is movably disposed on the foot tube, the locking plate is fixedly connected to the connecting plate, and an upper portion of the locking plate extends into any one of the locking tooth grooves; and
the locking mechanism and the connecting plate or the locking plate are locked with each other, to constrain the connecting plate and the locking plate from moving relative to the foot tube.

Preferably, the locking element is provided with a locking groove, the locking mechanism includes a locking rod moving upward and downward relative to the foot tube, and the locking rod can move between a first position and a second position relative to the foot tube;
when the locking mechanism is in a locking state, the locking rod is located at the second position, and the locking rod is inserted into the locking groove to form locking; and
when the locking mechanism is in an unlocking state, the locking rod is located at the first position, the locking rod is completely separated from the locking groove, and the locking element may move relative to the foot tube, to implement engagement or separation between the locking plate and the locking tooth groove.

Preferably, an elastic positioning element is disposed on the foot tube, a side wall, facing the elastic positioning element, of the locking rod is provided with a positioning groove, and when the locking rod moves to the second position, the elastic positioning element is embedded into the positioning groove, to perform positioning constraint on the locking rod.

Preferably, the elastic positioning element is a spring positioning bead, the spring positioning bead includes a base fixedly disposed on the foot tube, a rolling bead moving relative to the base is disposed in the base, and a spring is connected to the rolling bead and the base.

According to the present invention, compared with the prior art, the locking mechanism is disposed on the foot tube, and the locking mechanism is configured to perform position locking on the locking element, to constrain the locking element from separating from the locking tooth groove. The locking mechanism is used and may constrain a position of the locking element. When the locking element cannot be separated from the locking tooth groove, the locking element constrains the foot tube synchronously, so that the foot tube cannot be folded inward relative to the gimbal base. According to the present invention, based on the locking mechanism, the foot tube may be prevented from being folded inward, use stability of the tripod may be effectively improved, and a problem of tripod collapse caused by a strong acting force and the like may be prevented.

### BRIEF DESCRIPTION OF THE DRAWINGS

FIG. 1 is a schematic structural stereo diagram of a tripod;

FIG. 2 is a schematic structural sectional view 1 of a tripod;

FIG. 3 is a schematic structural enlarged view of a position A in FIG. 2;

FIG. 4 is a schematic structural sectional view 2 of a tripod;

FIG. 5 is a schematic structural enlarged view of a position B in FIG. 4;

FIG. 6 is a schematic diagram of connection between a gimbal base and a foot tube;

FIG. 7 is a schematic diagram 1 of a partial exploded state of a tripod;

FIG. 8 is a schematic diagram 2 of a partial exploded state of a tripod;

FIG. 9 is a schematic structural diagram in which a locking mechanism is in a locking state; and

FIG. 10 is a schematic structural diagram in which a locking mechanism is in an unlocking state.

### DETAILED DESCRIPTION OF THE EMBODIMENTS

The present invention is further described below with reference to the accompanying drawings and embodiments.

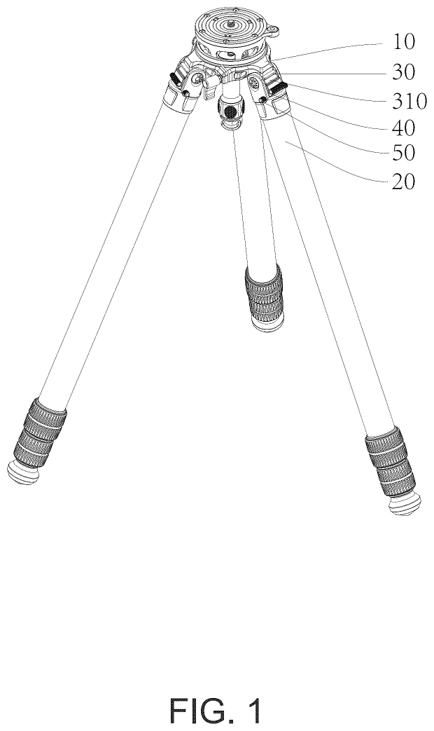

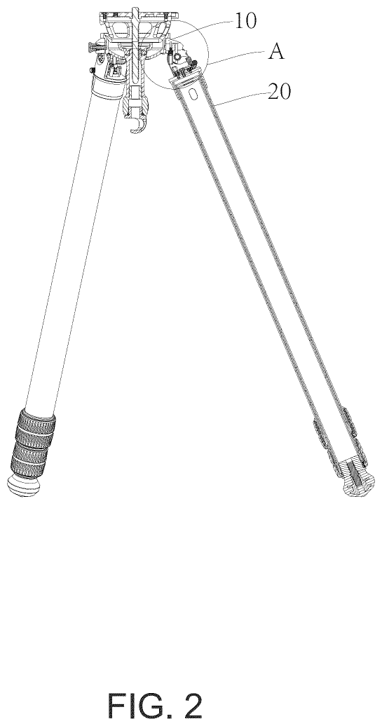

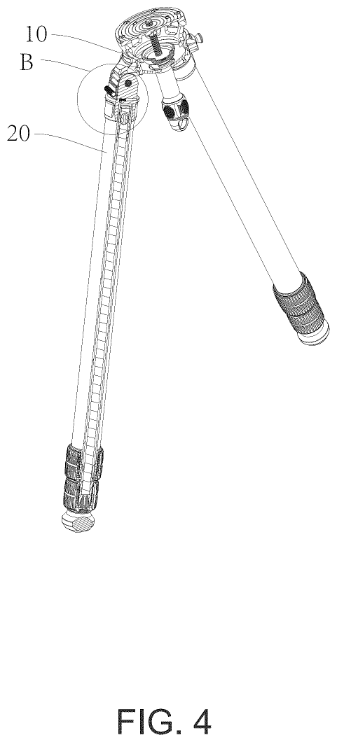

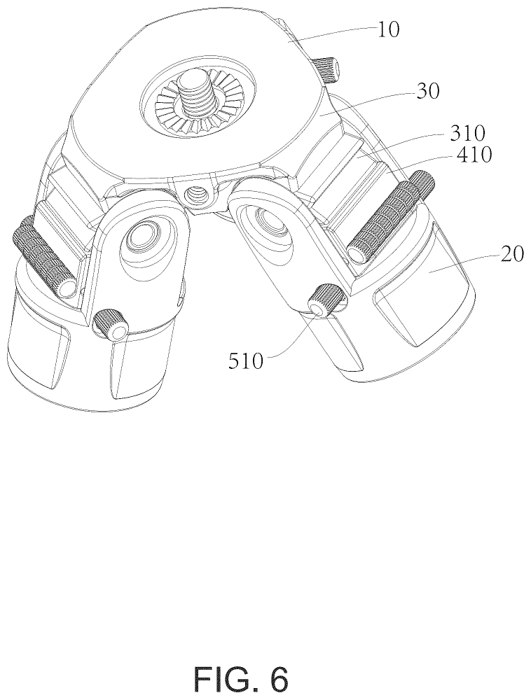

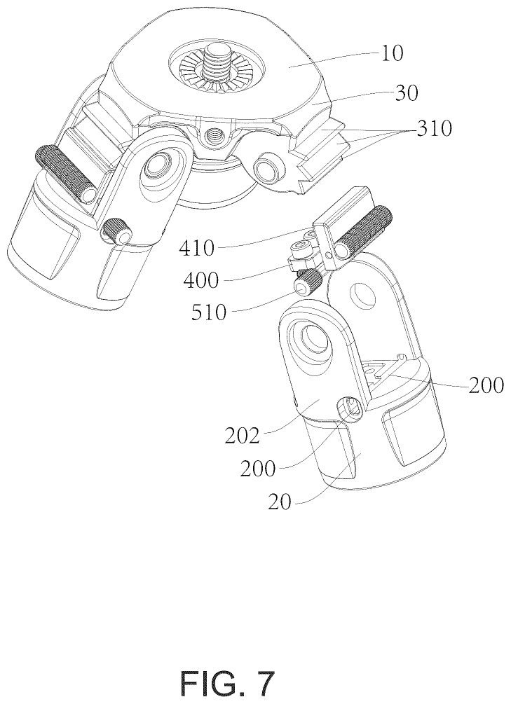

Referring to FIG. 1 to FIG. 10, a foot tube locking structure for a tripod includes a gimbal base 10 and a foot tube 20, where one end of the foot tube 20 is rotatably connected to the gimbal base 10, a locking tooth base 30 is disposed on the gimbal base 10, a plurality of locking tooth grooves 310 are arranged on the locking tooth base 30 along a rotating direction of the foot tube 20, a locking element 40 embedded into any one of the locking tooth grooves 310 is movably disposed on the foot tube 20, a locking mechanism 50 is disposed on the foot tube 20, and the locking mechanism 50 is configured to perform position locking on the locking element 40, to constrain the locking element 40 from separating from the locking tooth groove 310.

When the foot tube 20 needs to be rotatably folded inward relative to the gimbal base 10, the foot tube 20 is driven to rotate inward relative to the gimbal base 10. During rotation, the locking element 40 is separated from the locking tooth groove 310 under force, so that the foot tube 20 is rotatably folded inward. When the locking element 40 cannot be separated from the locking tooth groove 310, the foot tube 20 cannot be rotatably folded inward.

Based on the above embodiment, the locking mechanism is used and may constrain a position of the locking element. When the locking element cannot be separated from the locking tooth groove, the locking element constrains the foot tube synchronously, so that the foot tube cannot be folded inward relative to the gimbal base. According to the present invention, based on the locking mechanism, the foot tube may be prevented from being folded inward, use stability of the tripod may be effectively improved, and a problem of collapse caused by a strong acting force and the like may be prevented.

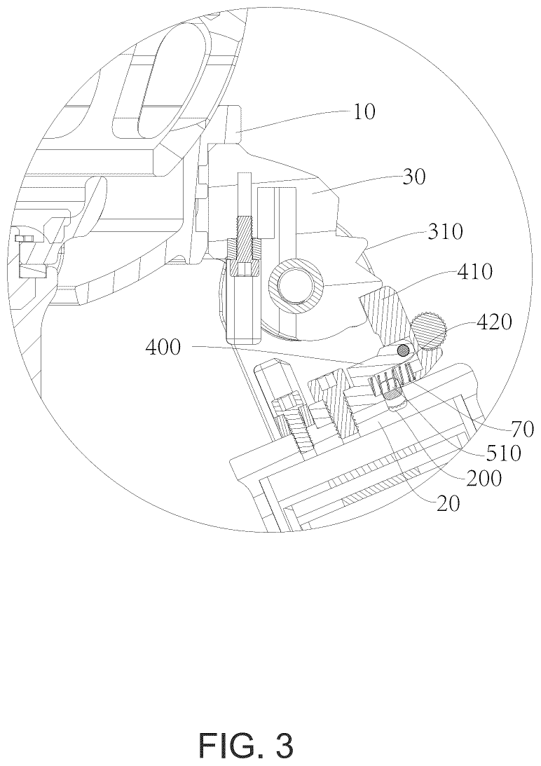

Referring to FIG. 3, a first embodiment of the locking element 40 is provided, and the locking element includes a connecting plate 400 and a locking plate 410, where the connecting plate 400 is disposed on the foot tube 20, a middle portion of the locking plate 410 is hinged with the connecting plate 400, and an upper portion of the locking plate 410 extends into any one of the locking tooth grooves 310; and the locking mechanism 50 abuts against a lower side wall surface in the locking plate 410, to constrain a lower portion of the locking plate 410 from flipping inward. In the embodiment, the locking mechanism 50 is configured to constrain the locking plate 410, so that the locking plate cannot flip and cannot be separated from the locking tooth groove 310. When the locking plate 410 cannot be separated from the locking tooth groove 310, the foot tube 20 cannot rotate relative to the gimbal base 10, to implement locking constraint.

Referring to FIG. 3, in the first embodiment of the locking element 40, the locking mechanism 50 includes a locking rod 510 moving upward and downward relative to the foot tube 20, and the locking rod 510 may move between a first position and a second position relative to the foot tube 20;
when the locking mechanism 50 is in a locking state, the locking rod 510 is located at the second position, and the locking rod abuts against the lower side wall surface in the locking plate 410; and
when the locking mechanism 50 is in an unlocking state, the locking rod 510 is located at the first position, the locking rod is separated from the lower side wall surface in the locking plate 410, and the locking plate 410 may rotate relative to the connecting plate 400, to enable the upper portion of the locking plate 410 to be separated from the locking tooth groove 310.

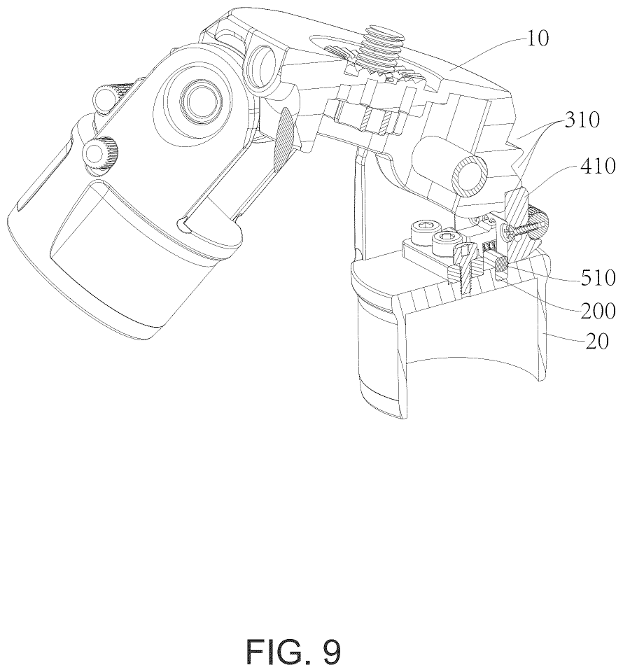

Referring to FIG. 9, the locking rod 510 is located at the second position, the locking mechanism 50 is in the locking state, and the locking rod 510 abuts against an inner side wall surface of the lower portion of the locking plate 410, to constrain rotation of the locking plate 410.

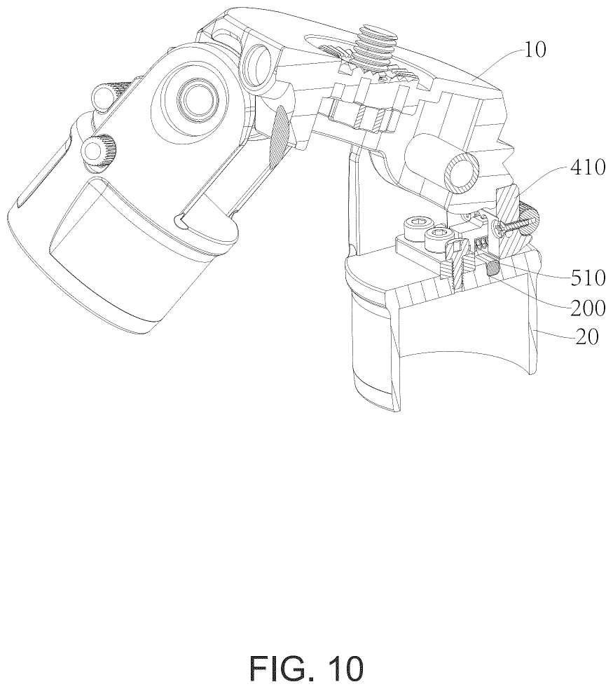

Referring to FIG. 10, the locking rod 510 is located at the first position, the locking mechanism 50 is in the unlocking state, position constraint of the locking rod 510 is not performed on the locking plate 410, and the locking plate 410 may rotate relative to the connecting plate 400.

Further, the locking rod 510 moves upward and downward relative to the foot tube 20, and during locking, the locking rod 510 is pulled to move from the first position to the second position. As shown in FIG. 3, when the locking rod 510 is located at the second position, the locking rod 510 abuts against the lower side wall surface in the locking plate 410 and can constrain the lower portion of the locking plate 410 from flipping inward. When the lower portion of the locking plate 410 is blocked by the locking rod 510 and cannot flip inward, the foot tube 20 also cannot be folded inward relative to the gimbal base 10. The foot tube is prevented from being folded inward due to a strong acting force, use stability of the tripod is effectively improved, and a problem of tripod collapse caused by the strong acting force and the like are prevented.

Referring to FIG. 3, in the first embodiment of the locking element 40, the locking element 40 further includes an elastic element 70, one end of the elastic element 70 is connected to the lower portion of the locking plate 410, the other end thereof is connected to the connecting plate 400 or the foot tube 20, and the elastic element 70 is configured to apply an outward movement acting force to the lower portion of the locking plate 410. The elastic element 70 is a spring, and a function of the elastic element is to apply the outward movement acting force to the lower portion of the locking plate 410. Since the middle portion of the locking plate 410 is hinged, when the outward movement acting force is applied to the lower portion of the locking plate 410, the upper portion of the locking plate 410 moves inward, so that the upper portion of the locking plate 410 is maintained in the locking tooth groove 310, to maintain locking of the foot tube 20. The locking merely is locking of outward flipping of the foot tube 20. An implementation of locking related to inward flipping and folding of the foot tube 20 always needs to rely on the locking rod 510 in the locking mechanism 50 to abut against the inner side wall surface of the lower portion of the locking plate 410.

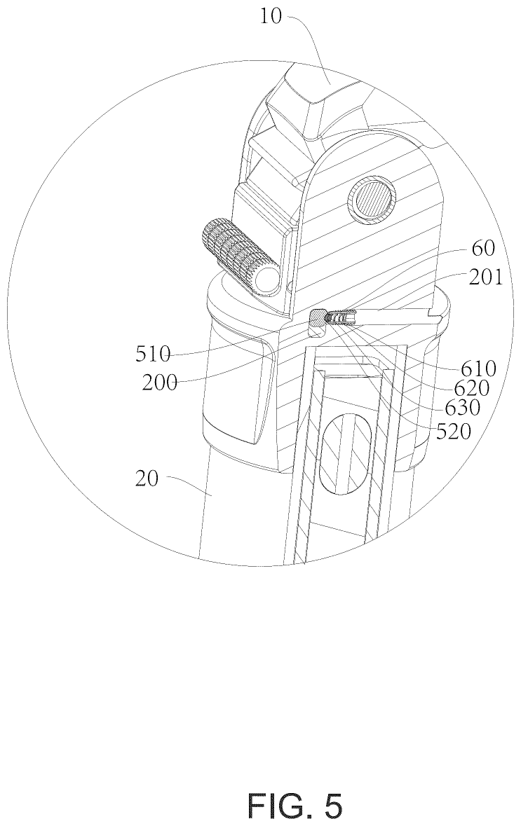

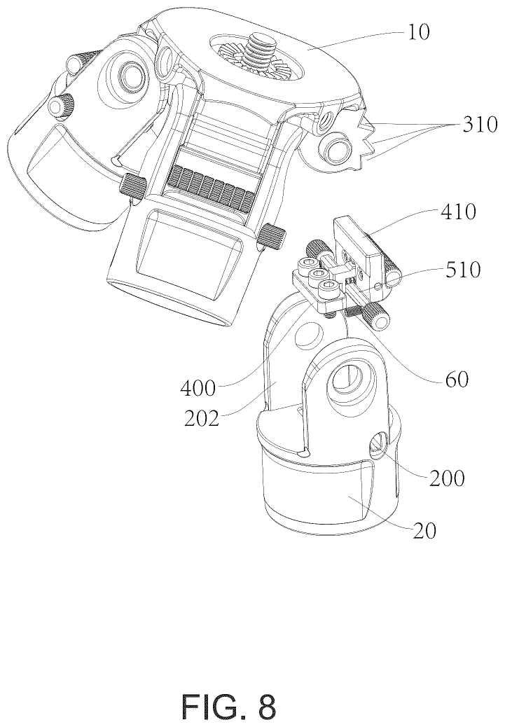

Referring to FIG. 5 and FIG. 8, an elastic positioning element 60 is disposed on the foot tube 20, a side wall, facing the elastic positioning element 60, of the locking rod 510 is provided with a positioning groove 520, and when the locking rod 510 moves to the second position, the elastic positioning element 60 is embedded into the positioning groove 520, to perform positioning constraint on the locking rod 510. A function of the elastic positioning element 60 is to enable the locking rod 510 to be maintained at the second position, to maintain locking to the locking plate 410, so that the locking plate 410 cannot move relative to the foot tube 20 and is maintained in the locking state all the time, thereby preventing the foot tube 20 from being folded inward.

Further, the elastic positioning element 60 is a spring positioning bead, the spring positioning bead includes a base 610 fixedly disposed on the foot tube 20, a rolling bead 630 moving relative to the base 610 is disposed in the base 610, and a spring 620 is connected to the rolling bead 630 and the base 610.

In the present invention, a second embodiment of the locking element 40 is provided, and the locking element 40 includes a connecting plate 400 and a locking plate 410, where the connecting plate 400 is movably disposed on the foot tube 20, the locking plate 410 is fixedly connected to the connecting plate 400, and an upper portion of the locking plate 410 extends into any one of the locking tooth grooves 310; and the locking mechanism 50 and the connecting plate 400 or the locking plate 410 are locked with each other, to constrain the connecting plate 400 and the locking plate 410 from moving relative to the foot tube 20. In the embodiment, the locking element 40 constrains the foot tube 20 from flipping outward by sliding relative to the foot tube 20. When the foot tube 20 is folded inward, the foot tube 20 rotates inward relative to the gimbal base 10. During the process, the locking element 40 needs to move outward, to enable the locking element 40 to be separated from the locking tooth groove 310, so that the foot tube 20 can be rotatably folded inward relative to the gimbal base 10. In the embodiment, the disposed locking mechanism 50 can constrain position movement of the locking element 40. When the locking element 40 cannot generate movement, that is, when the locking element 40 cannot be separated from the locking tooth groove 310, the foot tube 20 cannot rotate relative to the gimbal base 10 and cannot be rotatably folded inward, so that the foot tube is prevented from being folded inward due to a strong acting force, use stability of the tripod is effectively improved, and a problem of tripod collapse caused by the strong acting force and the like are prevented.

In the second embodiment of the locking element 40, the locking element 40 is provided with a locking groove 420, the locking mechanism 50 includes a locking rod 510 moving upward and downward relative to the foot tube 20, and the locking rod 510 may move between a first position and a second position relative to the foot tube 20.

As shown in FIG. 3, when the locking mechanism 50 is in a locking state, the locking rod 510 is located at the second position, and the locking rod 510 is inserted into the locking groove 420 to form locking; and
when the locking mechanism 50 is in an unlocking state, the locking rod 510 is located at the first position, the locking rod 510 is completely separated from the locking groove 420, and the locking element 40 may move relative to the foot tube 20, to implement engagement or separation between the locking plate 410 and the locking tooth groove 310. In the embodiment, the locking rod 510 moving upward and downward moves between the first position and the second position. When the foot tube 20 needs to be locked to prevent the foot tube 20 from being folded inward, the locking rod 510 is pulled from the first position to the second position, to enable the locking rod 510 to be in the locking groove 420, to constrain the locking element 40 from moving relative to the foot tube 20. When the locking element 40 cannot move relative to the foot tube 20, the locking element 40 cannot be separated from the locking tooth groove 310, and the foot tube 20 cannot rotate relative to the gimbal base 10 and cannot be rotatably folded inward, so that the foot tube is prevented from being folded inward due to a strong acting force, use stability of the tripod is effectively improved, and a problem of tripod collapse caused by the strong acting force and the like are prevented.

Further, a lower side of the locking groove 420 is provided with an opening, and the opening is to enable the locking rod 510 to enter the locking groove 420 when the locking rod 510 moving upward and downward may move from the first position to the second position, to implement locking.

Referring to FIG. 9 and FIG. 10, as shown in FIG. 9, an upper end of the foot tube 20 is provided with a guide groove 200, the locking rod 510 is movably disposed in the guide groove 200, an upper side of a middle portion of the guide groove 200 is provided with an opening, and when the locking rod 510 moves from the first position to the second position, the locking rod 510 at least partially passes through the opening on the upper side of the guide groove 200 to abut against and constrain the locking element 40, to implement locking. During unlocking, the locking rod 510 is pulled to move from the second position to the first position, to completely enter the guide groove 200. As shown in FIG. 10, in the state, the locking rod 510 cannot constrain the locking element 40 from moving relative to the foot tube 20, and the locking element 40 may move inward. At this time, the foot tube 20 may flip inward relative to the gimbal base 10, to implement folding.

Further, based on the above embodiment, two left and right ends of the guide groove 200 are provided with an opening, and two ends of the locking rod 510 located in the guide groove 200 pass through the guide groove 200 to extend to the outside. When a position of the locking rod 510 is adjusted, the two ends of the locking rod 510 are held to pull the locking rod to move upward and downward relative to the foot tube 20.

Further, as shown in FIG. 9, hinging lug bases 202 hinged with the gimbal base 10 are respectively disposed on left and right of the upper end of the foot tube 20, left and right of the guide groove 200 penetrate through the hinging lug base 202, the guide groove 200 located between two left and right hinging lug bases 202 is disposed on an upper end surface of the foot tube 20, an upper side of the guide groove 200 between the two hinging lug bases 202 is provided with an opening which is communicated with a space above the foot tube 20, to implement that the locking rod 510 comes to the space above the foot tube 20 to abut against and constrain the locking element 40 when the locking rod 510 moves upward, to implement locking.

Further, as shown in FIG. 5, the foot tube 20 is provided with a mounting hole 201 communicated with the guide groove 200, and the elastic positioning element 60 is disposed in the mounting hole 201.

Further, as shown in FIG. 5, the mounting hole 201 is disposed perpendicular to the guide groove 200, and the elastic positioning element 60 is disposed at one end, close to the guide groove 200, of the mounting hole 201.

In the description of the present invention, it should be understood that the orientations or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counter-clockwise”, and the like are in accordance with those shown in the accompanying drawings and intended only for the convenience of describing the present invention and simplifying the description rather than for indicating or implying that the referred device or element must be provided with a particular orientation or constructed and operated in a particular orientation; therefore, they should not be construed as limiting the present invention. The terms “first” and “second” are merely intended for a purpose of description, and shall not be understood as an indication or implication of relative importance or implicit indication of a quantity of indicated technical features.

The above shows and describes basic principles, main features, and advantages of the present invention. A person skilled in the art should understand that the present invention is not limited to the above embodiments, the descriptions in the above embodiments and specification are merely to illustrate the principles of the present invention, and various changes and improvements may be made to the present invention without departing from the spirit and scope of the present invention. These changes and improvements shall fall within the scope of protection claimed in the present invention. The scope of protection claimed in the present invention is defined by the appended claims and equivalents thereof.

What is claimed is:

1. A foot tube locking structure for a tripod, comprising a gimbal base (10) and a foot tube (20), wherein one end of the foot tube (20) is rotatably connected to the gimbal base (10), a locking tooth base (30) is disposed on the gimbal base (10), a plurality of locking tooth grooves (310) are arranged on the locking tooth base (30) along a rotating direction of the foot tube (20), a locking element (40) embedded into any one of the locking tooth grooves (310) is movably disposed on the foot tube (20), a locking mechanism (50) is disposed on the foot tube (20), and the locking mechanism (50) is configured to perform position locking on the locking element (40), to constrain the locking element (40) from separating from the locking tooth groove (310).

2. The foot tube locking structure for a tripod according to claim 1, wherein the locking element (40) comprises a connecting plate (400) and a locking plate (410), the connecting plate (400) is disposed on the foot tube (20), a middle portion of the locking plate (410) is hinged with the connecting plate (400), and an upper portion of the locking plate (410) extends into any one of the locking tooth grooves (310); and
the locking mechanism (50) abuts against a lower side wall surface in the locking plate (410), to constrain a lower portion of the locking plate (410) from flipping inward.

3. The foot tube locking structure for a tripod according to claim 2, wherein the locking mechanism (50) comprises a locking rod (510) moving upward and downward relative to the foot tube (20), and the locking rod (510) can move between a first position and a second position relative to the foot tube (20);
when the locking mechanism (50) is in a locking state, the locking rod (510) is located at the second position, and the locking rod abuts against the lower side wall surface in the locking plate (410); and
when the locking mechanism (50) is in an unlocking state, the locking rod (510) is located at the first position, the locking rod is separated from the lower side wall surface in the locking plate (410), and the locking plate (410) can rotate relative to the connecting plate (400), to enable the upper portion of the locking plate (410) to be separated from the locking tooth groove (310).

4. The foot tube locking structure for a tripod according to claim 3, wherein the locking element (40) further comprises an elastic element (70), one end of the elastic element (70) is connected to the lower portion of the locking plate (410), the other end thereof is connected to the connecting plate (400) or the foot tube (20), and the elastic element (70) is configured to apply an outward movement acting force to the lower portion of the locking plate (410).

5. The foot tube locking structure for a tripod according to claim 1, wherein the locking element (40) comprises a connecting plate (400) and a locking plate (410), the connecting plate (400) is movably disposed on the foot tube (20), the locking plate (410) is fixedly connected to the connecting plate (400), and an upper portion of the locking plate (410) extends into any one of the locking tooth grooves (310); and
the locking mechanism (50) and the connecting plate (400) or the locking plate (410) are locked with each other, to constrain the connecting plate (400) and the locking plate (410) from moving relative to the foot tube (20).

6. The foot tube locking structure for a tripod according to claim 5, wherein the locking element (40) is provided with a locking groove (420), the locking mechanism (50) comprises a locking rod (510) moving upward and downward relative to the foot tube (20), and the locking rod (510) can move between a first position and a second position relative to the foot tube (20);
when the locking mechanism (50) is in a locking state, the locking rod (510) is located at the second position, and the locking rod (510) is inserted into the locking groove (420) to form locking; and
when the locking mechanism (50) is in an unlocking state, the locking rod (510) is located at the first position, the locking rod (510) is completely separated from the locking groove (420), and the locking element (40) can move relative to the foot tube (20), to implement engagement or separation between the locking plate (410) and the locking tooth groove (310).

7. The foot tube locking structure for a tripod according to claim 3, wherein an elastic positioning element (60) is disposed on the foot tube (20), a side wall, facing the elastic positioning element (60), of the locking rod (510) is provided with a positioning groove (520), and when the locking rod (510) moves to the second position, the elastic positioning element (60) is embedded into the positioning groove (520), to perform positioning constraint on the locking rod (510).

8. The foot tube locking structure for a tripod according to claim 7, wherein the elastic positioning element (60) is a spring positioning bead, the spring positioning bead comprises a base (610) fixedly disposed on the foot tube (20), a rolling bead (630) moving relative to the base (610) is disposed in the base (610), and a spring (620) is connected to the rolling bead (630) and the base (610).
